(19) United States
(12) Patent Application Publication
(10) Pub. No.: US 2020/0173806 A1
(43) Pub. Date: Jun. 4, 2020

(54) MULTIMEDIA SYSTEM OF SHARED BICYCLE

(71) Applicant: HANGZHOU QINGQI SCIENCE AND TECHNOLOGY CO., LTD., Hangzhou (CN)

(72) Inventors: Gang LI, Hangzhou (CN); Guotai HE, Hangzhou (CN); Meimiao FENG, Hangzhou (CN); Zaixing LI, Hangzhou (CN); Sheng LIU, Hangzhou (CN)

(73) Assignee: HANGZHOU QINGQI SCIENCE AND TECHNOLOGY CO., LTD., Hangzhou (CN)

(21) Appl. No.: 16/784,513

(22) Filed: Feb. 7, 2020

Related U.S. Application Data
(63) Continuation of application No. PCT/CN2018/090047, filed on Jun. 6, 2018.

(30) Foreign Application Priority Data
Aug. 7, 2017 (CN) 201720982048.6
Feb. 6, 2018 (CN) 201820211278.7

(51) Int. Cl. G01C 21/36; H04L 29/06; G06F 3/16; H04R 1/02; G06F 3/14; G06F 3/041; B62J 50/22; B62J 45/10

(52) U.S. Cl. CPC G01C 21/3629; H04L 65/60; G06F 3/167; G06F 3/165; H04L 67/10; G06F 3/1423; G06F 3/041; B62J 50/22; B62J 45/10; H04R 1/028

(57) ABSTRACT

The present disclosure relates to the field of shared bicycles, and in particular, to a multimedia system of a shared bicycle. The multimedia system may include a lock main control unit, a cloud server, a display unit and a short message unit. The lock main control unit may be connected to the cloud server, the display unit and the short message unit, respectively. The display unit may include a storage device. The lock main control unit may detect a stored content of the storage device, and may control the short message unit to send a push signal to the cloud server when the stored content does not include multimedia data. The cloud server may send the multimedia data to the storage device based on the push signal. The lock main control unit may control the display unit to turn on when a lock of the shared bicycle is unlocked, and may control the display unit to turn off when the shared bicycle ends a trip. The multimedia system may download the multimedia data only when there is no multimedia data stored, and may delete the stored content periodically to release a storage space, which can facilitate a user to obtain more multimedia data.

### CROSS-REFERENCE TO RELATED APPLICATIONS

This application is a continuation of International Application No. PCT/CN2018/090047 filed on Jun. 6, 2018, which claims priority of Chinese Patent Application No. CN201820211278.7, filed on Feb. 6, 2018, and Chinese Patent Application No. CN201720982048.6, filed on Aug. 7, 2017, the contents of each of which are incorporated herein by reference.

### TECHNICAL FIELD

The present disclosure relates to a field of bicycle sharing, and in particular, to a multimedia system of a shared bicycle.

### BACKGROUND

Bicycle sharing refers to a provision of bicycle sharing services on campuses, subway stations, bus stations, residential areas, commercial areas, public service areas, etc., via cooperation between enterprises and the government, which is a new form of sharing economy.

When a user opens a bicycle sharing app, the user can view a distribution map of nearby bicycles that can be rented, make an appointment, etc. After a user finds a bicycle, the bicycle can be unlocked by scanning a quick response (QR) code with a mobile phone or by inputting a code. After the user finishes riding, the bicycle can be parked in an area where bicycles are allowed to be parked on both sides of a road. Then the bicycle can be locked and the use of the bicycle is finished.

However, for existing shared bicycles, there is no multimedia system on the bicycles. As an emerging platform, it cannot make good use of its inherent multimedia information transmission channels, which may cause a waste of resources. In addition, when a shared bicycle stores too much data, it is easy to cause a storage burden, therefore, it is necessary to delete data regularly. At the same time, the existing shared bicycles have no navigation function, accordingly, a user needs to use a mobile phone to navigate a trip while riding a bicycle, which is very dangerous and may cause traffic accidents.

Therefore, how to reasonably control a shared bicycle platform for multimedia data dissemination and regularly delete multimedia data, how to reasonably control a multimedia system for navigation, and further improve user experience, have been key research issues for those skilled in the art.

### SUMMARY

Aiming at the above-mentioned disadvantages of prior arts, the technical problem to be solved in the present disclosure is to provide a multimedia system for a shared bicycle to solve the problem that existing shared bicycles lack a multimedia play device and a navigation device and the problem that a storage space of the shared bicycle is insufficient.

In order to solve the technical problem, the present disclosure may provide a multimedia system of a shared bicycle. The multimedia system may include a lock main control unit, a cloud server, a display unit, and a short message unit. The lock main control unit may be connected to the cloud server, the display unit, and the short message unit, respectively. The display unit may include a storage device. The lock main control unit may detect a stored content of the storage device, and may control the short message unit to send a push signal to the cloud server when the stored content does not include multimedia data. The cloud server may send the multimedia data to the storage device based on the push signal. The lock main control unit may control the display unit to turn on when a lock of a shared bicycle is unlocked, and may control the display unit to turn off when the shared bicycle ends a trip.

Preferably, the lock main control unit may send a clear signal to the storage device every 24 hours. The storage device may clear the stored content based on the clear signal.

Preferably, the display unit may include a navigation module. The navigation module may perform a route navigation based on a GPS signal, and may direct the display unit to display a navigation route.

Preferably, the display unit may further include a first display screen. The first display screen may be set on a head of the bicycle.

Preferably, the display unit may further include a second display screen. The second display screen may be set above a rear tire of the bicycle.

Preferably, the first display screen may be configured to display navigation information or the multimedia data. The second display screen may be configured to display the multimedia data.

Preferably, the display unit may further include a touch screen. The touch screen may be attached to a front surface of the first display screen. The touch screen may be configured to sense a touch position of a user.

Preferably, the multimedia system may include a voice play unit. The voice play unit may be connected to the lock main control unit. The voice play unit may include a first speaker and a second speaker. The lock main control unit may control the first speaker to play the navigation voice information. The lock main control unit may control the second speaker to play multimedia voice information.

Preferably, the voice play unit may further include a voice controller. The voice controller may be connected to the first speaker and the second speaker respectively. The voice controller may be configured to control the second speaker to stop playing the multimedia voice information when it is detected that the first speaker plays the navigation voice information.

Preferably, the multimedia data may include a page, a picture, a video, a text, and a sound.

Compared with the prior arts, the beneficial effect of the present disclosure may be that, an advertising purpose may be achieved by designing a multimedia system for a shared bicycle. The multimedia system may include a display unit. The display unit may play multimedia data. Furthermore, the multimedia system may include a navigation module configured to provide a navigation to a user, which is convenient for the user to travel and can avoid a dangerous behavior of holding a navigation device to view a route while riding the shared bicycle. In addition, the multimedia system may download the multimedia data when there is no multimedia data stored and may delete the stored content periodically, which can replace the multimedia data regularly and reasonably use the storage space, prevent the use of the shared bicycle from being affected due to insufficient storage space, and further improve user experience.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a block diagram illustrating a multimedia system according to some embodiments of the present disclosure;

FIG. 2 is a block diagram illustrating a multimedia system according to some embodiments of the present disclosure;

FIG. 3 is a block diagram illustrating a multimedia system according to some embodiments of the present disclosure;

FIG. 4 is a block diagram illustrating a multimedia system according to some embodiments of the present disclosure; and

FIG. 5 is a block diagram illustrating a multimedia system according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

It will be understood that the terms “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

Spatial and functional relationships between elements are described using various terms, including “connected,” “attached,” and “mounted.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, attached, or positioned to another element, there are no intervening elements present. Other words used to describe the relationship between elements should be interpreted in a like fashion (e.g., “between,” versus “directly between,” “adjacent,” versus “directly adjacent,” etc.).

It should also be understood that terms such as “top,” “bottom,” “upper,” “lower,” “vertical,” “lateral,” “above,” “below,” “upward(s),” “downward(s),” “left-hand side,” “right-hand side,” “horizontal,” and other such spatial reference terms are used in a relative sense to describe the positions or orientations of certain surfaces/parts/components of the brake system with respect to other such features of the brake system when the brake system is in a normal operating position and may change if the position or orientation of the brake system changes.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

For illustration purposes, the following description is provided to help better understanding a multimedia system of a shared bicycle. It is understood that this is not intended to limit the scope of the present disclosure. For persons having ordinary skills in the art, a certain amount of variations, changes and/or modifications may be deducted under the guidance of the present disclosure. Those variations, changes and/or modifications do not depart from the scope of the present disclosure.

Preferred embodiments of the present disclosure will be described in detail with reference to accompanying drawings.

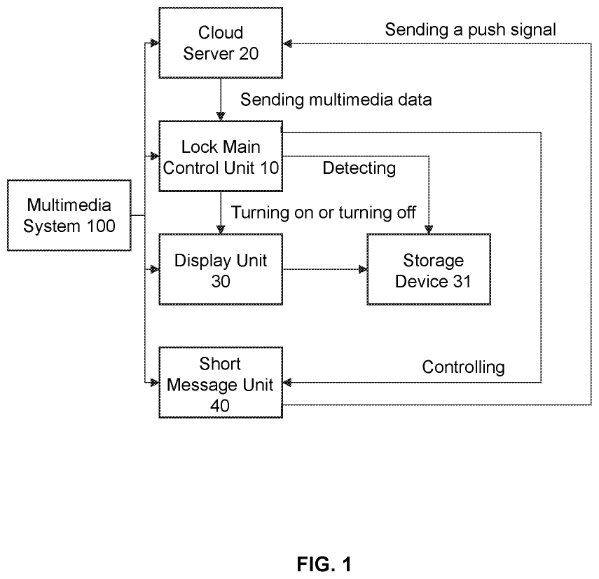

As shown in FIG. 1 to FIG. 5, the present disclosure provides a preferred embodiment of a multimedia system 100.

As shown in FIG. 1, a multimedia system 100 of a shared bicycle may include a lock main control unit 10, a cloud server 20, a display unit 30, and a short message unit 40. The lock main control unit 10 may be connected to the cloud server 20, the display unit 30, and the short message unit 40, respectively. The display unit 30 may include a storage device 31.

In some embodiments, the lock main control unit 10 may detect a stored content of the storage device 31 and control the short message unit 40 to send a push signal to the cloud server 20 when the stored content does not include multimedia data. The cloud server 20 may send the multimedia data to the storage device 31 based on the push signal. The lock main control unit 10 may control the display unit 30 to turn on when the lock of the shared bicycle is unlocked. The lock main control unit 10 may control the display unit 30 to turn off when the shared bicycle ends a trip. The display unit 30 may play the multimedia data when it is turned on. When the lock main control unit 10 detects that the storage device 31 stores the multimedia data, the short message unit 40 may not send the push signal to the cloud server 20, thereby saving a storage space and preventing a user from being affected due to an insufficient memory of the storage device 31. In some embodiments, the lock main control unit 10 may be a main control circuit board configured in a lock of the shared bicycle. In some embodiments, the main control circuit board may include a short message circuit configured to send a short message. For example, the short message circuit may be the short message unit 40. In some embodiments, a separate short message circuit board may be connected to the main control circuit board for data interaction.

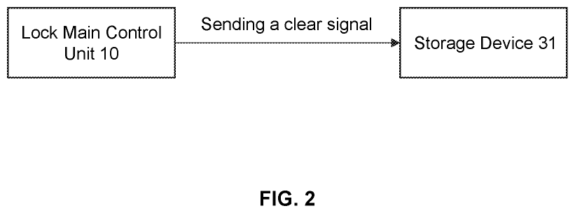

As shown in FIG. 2, the lock main control unit 10 may send a clear signal to the storage device 31 at an arbitrary time interval (e.g., every 24 hours). The storage device 31 may clear the stored content based on the clear signal. The lock main control unit 10 clears the stored content of the storage device 31 periodically to ensure that there is sufficient storage space in the storage device 31. Meanwhile, a user can obtain different multimedia data at different time periods, thereby obtaining more information.

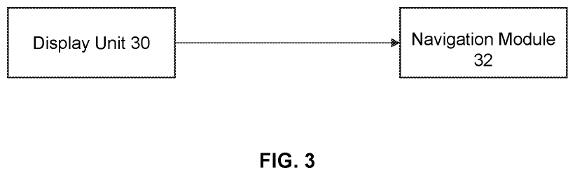

As shown in FIG. 3, the display unit 30 may include a navigation module 32. The navigation module 32 may perform a route navigation based on a GPS signal and display a navigation route on the display unit 30. By providing the navigation module 32 on the shared bicycle, when a user rides a shared bicycle, operations such as a route navigation, a location search, a location search of surrounding public facilities, etc. can be implemented, which can improve user experience and avoid a dangerous behavior of watching mobile navigation while riding the shared bicycle. In some embodiments, the main control circuit board may include a navigation circuit configured for navigation. For example, the navigation circuit may be the navigation module 32. In some embodiments, a separate navigation circuit board may be connected to the main control circuit board for data interaction.

In some embodiments, the navigation module 32 may include a GPS signal transmitting and receiving antenna and a GPS signal processing chip. In some embodiments, the GPS signal processing chip may obtain a GPS signal via the GPS signal transmitting and receiving antenna, which may realize a route navigation of the shared bicycle. In some embodiments, the GPS signal processing chip may upload position information via the GPS signal transmitting and receiving antenna, which may realize a precise navigation of the shared bicycle.

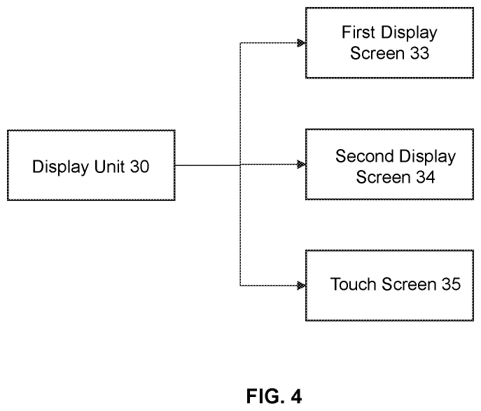

As shown in FIG. 4, the display screen 21 may include a first display screen 211. The first display screen 211 may be set on a head of the shared bicycle, so that the user can observe information on the display 21 during riding. In some embodiments, the display screen 21 may be connected to a power source of the shared bicycle. The power source may be charged by a solar charging device and a hub dynamo. In some embodiments, the display screen 21 may communicate with the lock main control unit 10 via a wired connection or a wireless connection. The wireless connection may include a Bluetooth communication, a WIFI communication, a radio frequency communication, a mobile communication, etc. In some embodiments, if the display screen 21 communicates with the lock main control unit 10 via the wired connection, wires may be configured in a frame of the shared bicycle, which can improve the overall beauty of the shared bicycle.

In some embodiments, the display screen 21 may further include a second display screen 212. In some embodiments, the second display screen 212 may be set above a rear tire of the shared bicycle. For example, the second display screen 212 may be set on a conspicuous position, such as a seat, a wheel bracket, etc.

The first display screen 33 may be configured to display multimedia data or a navigation route. The second display screen 34 may be configured to display the multimedia data. In some embodiments, the first display screen 33 may be provided with a switch. If a user turns on the switch when the first display screen 33 is turned on, the first display screen 33 may display the navigation route. If the user does not turn on the switch when the first display screen 33 is turned on, the first display screen 33 may display the multimedia data.

In some embodiments, the display unit 30 may further include a touch screen 35. The touch screen 35 may be attached to a front surface of the first display screen 33. The touch screen 35 may be configured to sense a touch position of the user, thereby realizing human-computer interaction.

In some embodiments, the touch screen 35 may be an infrared touch screen, a capacitive touch screen, a nano touch screen, a resistive touch screen, or the like, or any combination thereof.

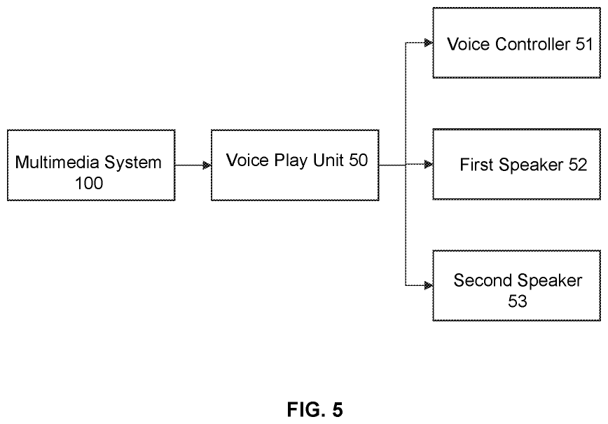

In some embodiment, as shown in FIG. 5, the multimedia system 100 may further include a voice play unit 50. The voice play unit 50 may be connected to the lock main control unit 10. The voice play unit 50 may include a first speaker 52 and a second speaker 53. The lock main control unit 10 may control the first speaker 52 to play navigation voice information. The lock main control unit 10 may control the second speaker 53 to play multimedia voice information.

In some embodiments, the voice play unit 50 may further include a voice controller 51. The voice controller 51 may be connected to the first speaker 52 and the second speaker 53, respectively. The voice controller 51 may be configured to control the second speaker 53 to stop playing the multimedia voice message when it is detected that the first speaker 52 plays the navigation voice message, thus the second speaker 53 may be prevented from playing multimedia voice information when the first speaker 52 plays the navigation voice information, which may result in that the user cannot obtain route navigation and affect user use.

In some embodiments, the main control circuit board may include a voice play circuit configured to play voice. For example, the voice play circuit may be the voice play unit 50. In some embodiments, a separate voice play circuit board may be connected to the main control circuit board for data interaction. In some embodiments, the voice controller 51 may be a sub-circuit embedded in the main control circuit board. In some embodiments, a separate control circuit board may be connected to the main control circuit board for data interaction. In some embodiments, a separate control circuit board may be connected to the voice play circuit board for data interaction.

In some embodiments, the multimedia data may include a page, a picture, a video, a text, a sound, or the like, or any combination thereof. In some embodiments, the page may cover an entire display area or part of the display area. The picture and the video may be displayed in an embedded manner, such as pop-ups, fade-ins, etc. The picture may be a picture collection. The text may be relevant text content displayed in the part of the display area of the display screen, or relevant text inserted when playing other multimedia data. The sound may be played based on corresponding multimedia information, or may be played separately.

In summary, the above description is only a preferred embodiment of the present disclosure, and not intended to limit the scope of the present disclosure. Any modification, equivalent replacement, improvement, or the like, made within the spirit and principle of the present disclosure do not depart from the scope of the present disclosure.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present disclosure are not limited to that precisely as shown and described.

1. A multimedia system of a shared bicycle, comprising: a lock main control unit, a cloud server, a display unit, and a short message unit, the lock main control unit being connected to the cloud server, the display unit, and the short message unit, respectively; the display unit including a storage device, wherein,
the lock main control unit detects a stored content of the storage device and controls the short message unit to send a push signal to the cloud server when the stored content does not include multimedia data;
the cloud server sends the multimedia data to the storage device based on the push signal; and
the lock main control unit controls the display unit to turn on when a lock of the shared bicycle is unlocked and controls the display unit to turn off when the shared bicycle ends a trip.

2. The multimedia system of claim 1, wherein
the lock main control unit sends a clear signal to the storage device at a preset time interval; and
the storage device clears the stored content based on the clear signal.

3. The multimedia system of claim 1, wherein the display unit includes a navigation module, wherein the navigation module is configured to perform a route navigation based on a GPS signal.

4. The multimedia system of claim 1, wherein the display unit further includes a first display screen, the first display screen being set on a head of the shared bicycle.

5. The multimedia system of claim 1, wherein the display unit further includes a second display screen, the second display screen being set above a rear tire of the shared bicycle.

6. The multimedia system of claim 4, wherein
the first display screen is configured to display navigation information or the multimedia data.

7. The multimedia system of claim 4, wherein the display unit further includes a touch screen, the touch screen being attached to a front surface of the first display screen.

8. The multimedia system of claim 1, further comprising: a voice play unit, wherein
the voice play unit is connected to the lock main control unit,
the voice play unit includes a first speaker and a second speaker,
the lock main control unit controls the first speaker to play navigation voice information and the lock main control unit controls the second speaker to play multimedia voice information.

9. The multimedia system of claim 8, wherein the voice play unit further includes a voice controller, wherein the voice controller is connected to the first speaker and the second speaker respectively.

10. The multimedia system of claim 1, wherein the multimedia data includes at least one of a page, a picture, a video, a text, or a sound.

11. The multimedia system of claim 2, wherein the preset time interval is 24 hours.

12. The multimedia system of claim 3, wherein the navigation module is further configured to direct the display unit to display a navigation route.

13. The multimedia system of claim 5, wherein the second display screen is configured to display the multimedia data.

14. The multimedia system of claim 7, wherein the touch screen is configured to sense a touch position of a user.

15. The multimedia system of claim 7, wherein the touch screen includes at least one of an infrared touch screen, a capacitive touch screen, a nano touch screen, or a resistive touch screen.

16. The multimedia system of claim 9, wherein the voice controller is configured to control the second speaker to stop playing the multimedia voice information when it is detected that the first speaker plays the navigation voice information.
